(19) United States
(12) Patent Application Publication
(10) Pub. No.: US 2003/0216959 A1
(43) Pub. Date: Nov. 20, 2003

(54) System and method for rewarding participation in an auction

(76) Inventor: Vincent E. Vitti, Saddle River, NJ (US)

Correspondence Address: BAKER & BOTTS, 30 ROCKEFELLER PLAZA, NEW YORK, NY, 10112

(21) Appl. No.: 10/146,011

(22) Filed: May 15, 2002

(51) Int. Cl. G06F 17/60

(52) U.S. Cl. 705/14; 705/37

(57) ABSTRACT

A system and method are provided for rewarding participation in an auction where a first user places an item up for auction on a central database. A first potential buyer places a first bid at a first price for the item on the central database. A second potential buyer places a subsequent bid at a second bid price, exceeding the first price at least by a predetermined bid increment, to become a current high bidder for the item. When the auction is complete, the current high bidder wins the auction and the central database then records an award to non-winning bidders, such as the first potential buyer, as an incentive for future participation in other auctions. The reward can be offered to each unique bidder who does not win the auction, the last losing bidder, or some other variants of non winning bidders. The awards accumulated by non-winning bidders can be applied to future purchases where the user wins a subsequent auction.

### FIELD OF THE INVENTION

The present invention relates generally to systems for auctioning items and more particularly relates to an online auction system providing bidding incentives.

### BACKGROUND OF THE INVENTION

Auctions exist as a way to buy and sell goods and services. In essence, an auction occurs when a seller offers an item to a group of buyers for the highest price one of the group of buyers is willing to pay. In a traditional auction, the person running the auction, the auctioneer, starts the bidding at a first price set by the seller. Generally, a first buyer who wants the item for the first price bids that price, the auctioneer then raises the price by an amount and asks if anyone else would be willing to bid a second price for the item. If there is a second buyer who wishes to bid the second price for the item he or she does so and the cycle continues until a final bid price is reached, e.g., a price above which there are no bids.

Traditionally, auctions have been held at auction houses. Auction houses include companies such as Christie's and Sotheby's. For an auction to occur at an auction house, a seller must decide to auction an item and entrust the auctioning of that item to the auction house. The auction house then publicizes the auction's time and place. At the appointed time and place the auction occurs and the item is auctioned off to a group of people who gather at the auction house.

The internet has provided the capability to create new, virtual auction houses that can reach out to a larger audience than traditional auction houses were able to reach. The internet has evolved from an information repository to a virtual market for real goods. Currently, consumers seeking goods can purchase virtually anything they need on the Internet. During this evolution, online web sites started to appear which auction real goods. These sites take the place of an auctioneer and an auction house. In an online auction a selling user offers an item for auction on a web site. The selling user generally specifies the minimum price he or she will accept for the item, the starting date for the auction, and the closing date for the auction. Other users, the buying users, bid on the item. The online web site generally records the information provided by the seller, and begins auctioning of the item after the starting date for the auction. With the large number of users on the Internet these sites have become popular and useful. One of the largest online auction sites is ebay.com which offers a large number of items for auction each day.

As online and offline auctions become increasingly popular, purchasing goods through auctions becomes increasingly competitive. Many users bid for the same item, but only one user gets the item. Users who did not make the high bid, and thus do not win the auction, become frustrated and some of those users seek out alternate ways, including other auction sites, online stores, or retail establishments, to purchase the goods they desire. Clearly, there remains a need for an improved system and method for retaining customers at online and offline auctions.

### OBJECTS AND SUMMARY OF THE INVENTION

An object of the present invention is to provide an auction system and method where the users who bid on the items are rewarded for their participation in an auction.

Thus, a system according to an exemplary embodiment of the present invention is provided to achieve this object. The system includes a first user, a second user, a third user, and a central database. The central database, the first user, the second user and the third user communicate over a network. The first user puts an item up for auction on the central database. The second user places a first bid at a first price for the item. The third user places a second bid at a second price exceeding the first price for the item. The second user receives a reward for bidding on the item and being out bid by the third user.

Preferably, the first user describes the item in an item profile. The item profile preferably includes a name for the item, a description for the item, an open date for the auction of the item, a close date for the auction, a reserve price for the item, and a bid increment for the item.

In one embodiment, the reward is not credited to the recipient until the close date for the auction. The reward may be valued at fifty percent of the bid increment.

Preferably, the users create a user profile before being able to put an item up for auction or bid on an item.

In an alternate embodiment, a system for auctioning items is provided. The system includes a communications network, at least one seller connected to a central database through the communications network, and a group of buyers connected to the central database through the communications network. The system further includes one of the at least one seller putting an item up for auction on the central database. A first one of the plurality of buyers bidding a first bid of a first price for the item on the central database. A second one of the group of buyers bidding a second bid of a second price exceeding the first price for the item on the central database, and the central database awarding the first one of the plurality of buyers a reward for bidding on the item.

In a further alternate embodiment, a central server computer is provided which can provide auction services to a group of buyers and sellers. The central server computer includes a communications interface for operatively coupling the central server computer to a communications network, digital storage media maintaining an auction database, and a processor. The processor is coupled to both the communications interface and the digital storage media. The processor creates a database record in the digital storage media in response to data received via the communications interface from a seller posting an item for auction. The processor makes the database record available to a plurality of buyers via the communications interface. The processor records a first bid from a first buyer at a first price for the item in the digital storage media, records a second bid from a second buyer at a second price exceeding the first price for the item in the digital storage media, and records an award to the first buyer in the digital storage media for bidding on the item.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a simplified block diagram illustrating an overview of the present system.

FIG. 2 is a simplified flow chart illustrating an overview of the present system.

FIG. 3 is a simplified flow chart illustrating the steps involved when a user communicates with the present system.

FIG. 4 is a simplified flow chart illustrating the browse auctions process.

FIG. 5 is a simplified flow chart illustrating the bid process.

FIG. 6 is a simplified flow chart illustrating the item purchase process.

FIG. 7 is a simplified flow chart illustrating the auction close process.

FIG. 8 is a simplified schematic diagram of a user profile.

FIG. 9 is a simplified schematic diagram of an item profile.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF PREFERRED EMBODIMENTS

The invention is herein described with respect to online auctioning, but it will be recognized that the system and the configuration of the system can be likewise arranged for traditional auctions.

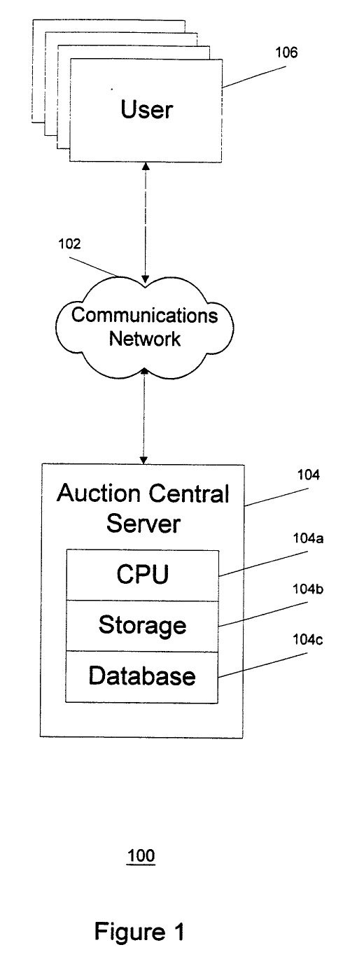

FIG. 1 is a block diagram illustrating a system 100 for the online auctioning of items over a communications network 102, preferably the Internet. A plurality of user computer terminals 106 can connect to an auction central server 104 through the communications network 102. The user computers 106 can take any number of known forms including personal computer, PDA, television set top box, and the like. The auction central server 104 maintains a central processing unit 104a, data storage capabilities 104b, and a central database 104c. To initiate an auction one of the plurality of users 106 must post an item profile 900 to the database 104c on the auction central server 104.

Referring now to FIGS. 1 and 9, to begin the auctioning of an item, one of the plurality of users 106 must provide an item profile 900 to the auction central server 104. The auction central server 104 stores the item profile 900 in the auction database 104c. The item profile 900 preferably contains: six user specified fields and five system specified fields. The six user specified fields are: an item name field 902, an item description field 904, an open date field 906, a close date field 908, a reserve price field 910, and a bid increment field 912. The five system fields are: a seller's username field 914, a current high bid field 916, a current high bidder field 918, a last high bid field 920, and a last high bidder field 922.

The item name field 902 is a data field and is the label under which the item will be auctioned. The item description field 904 is an optional field which describes characteristics of the item which is being auctioned to a prospective buyer. The open date field 906 is an optional field. The open date field 906 is used to define when the auction opens for general bidding. If the field is left blank, the auction is opened as of the date of the posting of the item profile 900 to the auction central server 104. No bids are generally accepted before the open date of the auction. The close date field 908 is generally an optional field and is used to define when the auction closes. A default value may be provided for this field which is overridden by the close date 208 of the item profile 900 if one is specified. No bids are accepted after the close date of an auction. The reserve price field 910 is an optional field. The reserve price field 910 is used to specify the lowest price a user is willing to accept for the item. For example, if a seller is willing to accept $30 for the item the seller is auctioning, then the seller may specify the value recorded in the reserve price field 910 as $30. If during the auction $30 or more is bid on the item, the seller must sell the item for the highest price bid during the auction. If during the auction less than $30 is bid on the item, the seller does not have to sell the item. The value of the reserve price field 910 is not provided to the bidder, however, an indication of whether or not the reserve price stored in the reserve price field 910 has been met is provided. The last seller-specified field in the item profile 900 is the bid increment field 912. The bid increment field 912 is an optional field. The bid increment field 912 is used to define the minimum amount by which a new bid must exceed an old bid. For example, if the current bid on an item is $100, and the bid increment field 912 is specified at $10, then the next bid must be for $110 or more. No new bid for under $110 will be accepted. A default bid increment can also be provided in the bid increment field 912. The default bid increment can be set to an absolute value, such as $5, or can be set to a relative value, such as 5% of the reserve price field 910. The default value is overridden if the bid increment field 912 is specified.

The seller's username field 914 is a system field written by the auction central server 104. After a user posts the item profile 900, the auction central server 104 writes the user's username into the seller's username field 914. The current high bid field 916 is a system field and is written by the auction central server 104 once a bid has been placed on the item. The current high bid field 916 is initialized to a value outside the accepted range when the item profile 900 is created. The current high bidder field 918 is a system field and is written by the auction central server 104 once a bid has been placed on the item. The current high bidder field 918 is initialized to a value outside the accepted range when the item profile 900 is created. The last high bid field 920 is a system field and is written by the auction central server 104. The last high bidder field 922 is a system field and is written by the auction central server 104.

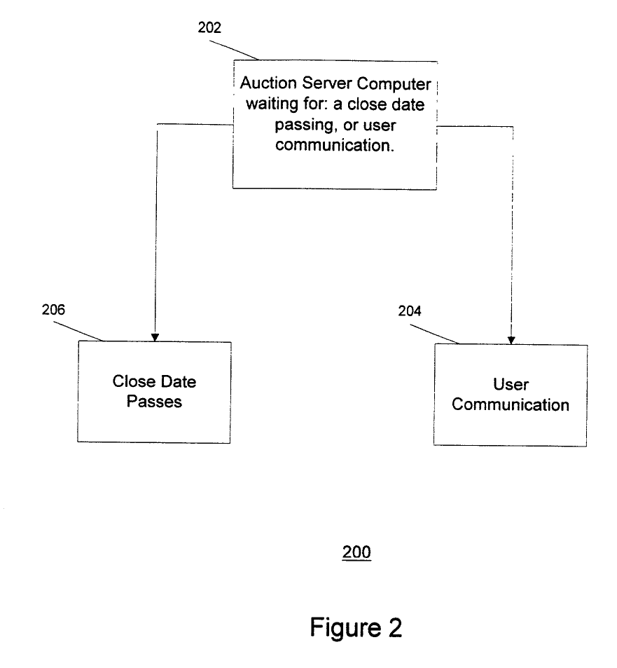

FIG. 2 is a flow chart 200 depicting the process by which an auction is conducted in accordance with the present method. The auction central server 104 remains in a wait state 202 until one of the following events occurs: a user communicates with the auction central server 104 or a close date specified in an item profile 900 passes. If a user communicates with the auction server computer 104, the auction server computer 104 executes process block 204. If a close date passes the auction central server 104 executes process block 206.

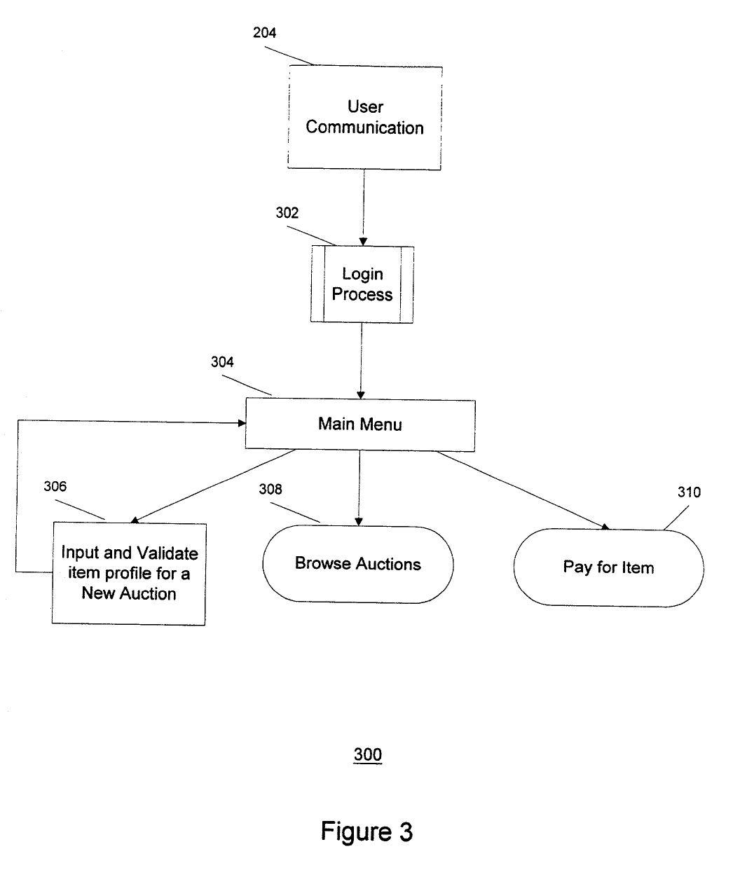

The auction central server 104 executes process block 204 in response to a communication from a user. Upon execution of process block 204, the auction central server 104 advances to the login process 302 shown in FIG. 3. Executing process block 302 causes the auction central server 104 to verify that the user is logged into the system. If the user is logged into the system already, the auction central server 104 executes process block 304. If the user is not logged into the system, the auction central server 104 prompts the user to indicate whether the user has an account on the system. If the user has an account on the system, the user is prompted to log into the system. If the user does not have an account on the system, the user is prompted to create a new account. After the user has logged into the system the auction central server 104 executes process block 304.

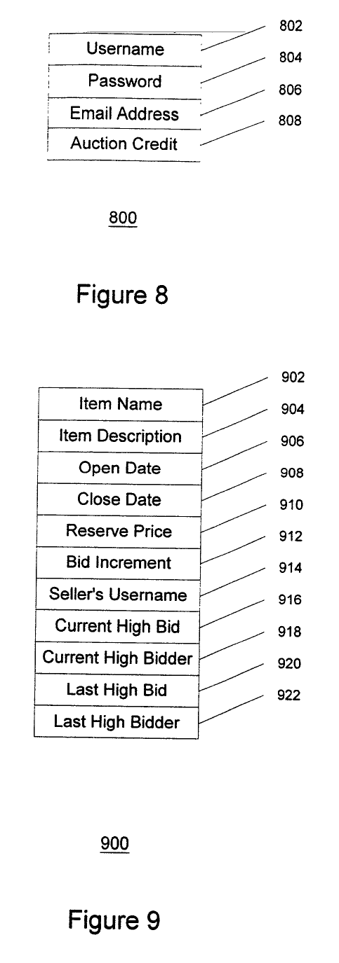

The user creates a new account by completing a user profile 800 shown in FIG. 8. The user profile 800 preferably includes: a username field 802, a password field 804, an email address field 806, and an auction credit field 808. The username field 802 stores the user's name. The password field 804 stores the user's password. The email address field 806 stores the user's email address. And the auction credit field 808 stores the user's accumulated credit. Upon creation of the account the auction credit field 808 is initialized to zero. In one embodiment, the user profile 800 also includes the user's address, credit card information, and the like.

After the login process is complete, the auction central server 104 executes the process block 304, shown in FIG. 3, which causes the auction central server 104 to display a main menu on the user's computer. The user main menu allows the user to choose to post a new item profile 900, browse auctions, or pay for an item which the user was the high bidder on. If the user chooses to post a new item profile 900, the auction central server executes process block 306. If the user chooses to browse auctions, the auction central server executes process block 308. If the user chooses to pay for an item, the auction central server 104 executes process block 310.

Once the process block 306 is executed, the auction central server 104 prompts the user to specify values for the item name field 902, the item description field 904, the open date field 906, the close date field 908, the reserve price field 910, and the bid increment field 912. Once the user inputs the information, the user uploads the profile to the auction central server 104. The optional fields may be left blank. The auction central server 104 writes the user's username into the seller's username field 914 and initializes the current high bid field 916 and the current high bidder field 918, such as to values outside the accepted range. The auction central server 104 prompts the user to verify the information. If the user indicates that the information is correct, the auction central server 104 stores the item profile 900 into the database 104c, and returns to wait state 202. If the user indicates that the information is incorrect the user has the option to correct the information or abandon the posting of the item profile 900. If the user corrects the information, the item profile 900 is stored in the database 104c and the central auction server 104 returns to the wait state 202. If the user abandons the posting of the item profile 900, the central auction server 104 discards the information and returns to the wait state 202.

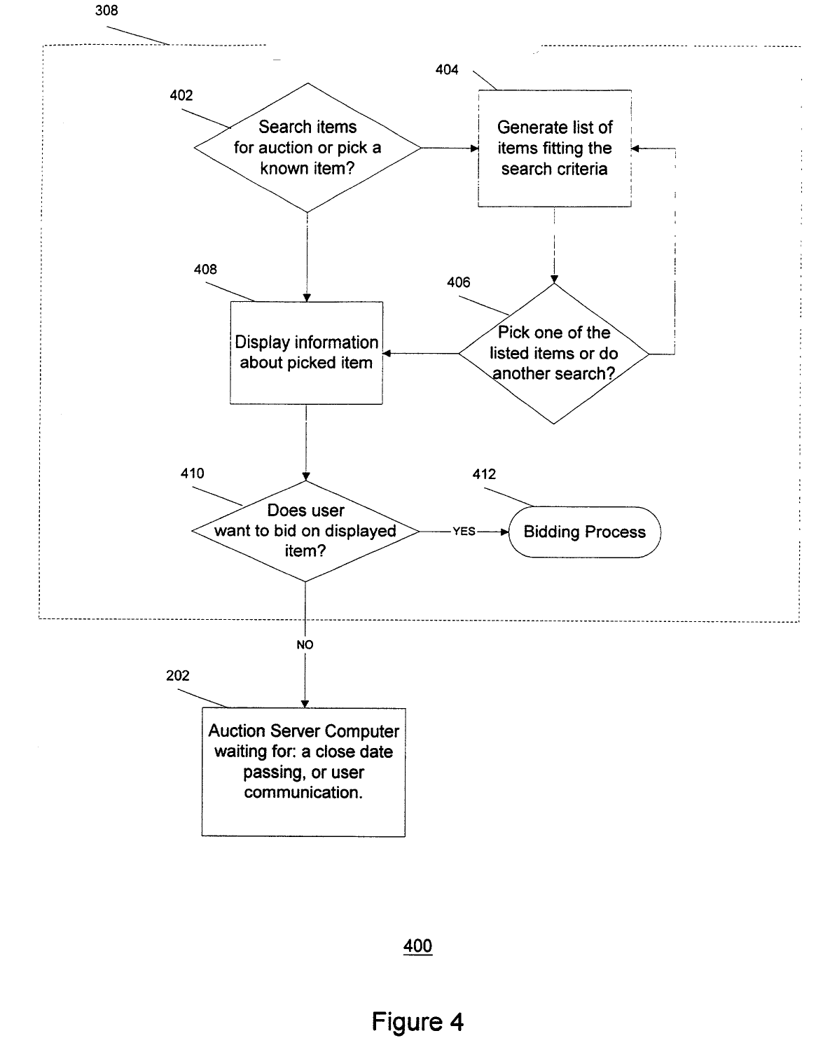

The process block 308 is shown in more detail in FIG. 4. The auction central server 104 begins executing process block 308 by executing decision block 402. The auction central server 104 presents the user with an option to search the item profiles currently stored in the database 104c or to display information on a particular item. If the user elects to search the item profiles currently stored in the database 104c the process block 404 is executed. If the user elects to display information on a particular item, the user provides the item name, or other item indicia, and the process block 408 is executed.

In executing process block 404, the auction central server 104 presents the user with a search form. The search form allows the user to search the item profiles 900 stored in the database 104c based on any, some, or all of the fields of the item profile 900. The user completes the search form and submits the search query to the auction central server 104. The search is conducted and control passes to decision block 406.

The auction central server 104 executes the decision block 406, which causes the auction central server 104 to display a list of the results of the search to the user. From this point the user can view information about a particular item, or the user can perform another search. If the user indicates to the auction central server 104 that the user wishes to view information on a particular item, the user selects the particular item from the list, and the auction central server 104 executes process block 408. If the user indicates that the user wants to perform another search, the auction central server 104 executes process block 404.

Executing the process block 408 causes the auction central server 104 to display detailed information about a particular item to the user. The particular item is specified in either the decision block 402 or decision block 406. After the information is displayed, the auction central server 104 executes decision block 410.

Executing decision block 410 causes the auction central server 104 to present the user with the option to bid on the item specified on the user's screen or return to the main menu. If the user elects to bid on the item, the auction central server 104 executes process block 412. If the user does not want to bid on the item the process block 202 is executed.

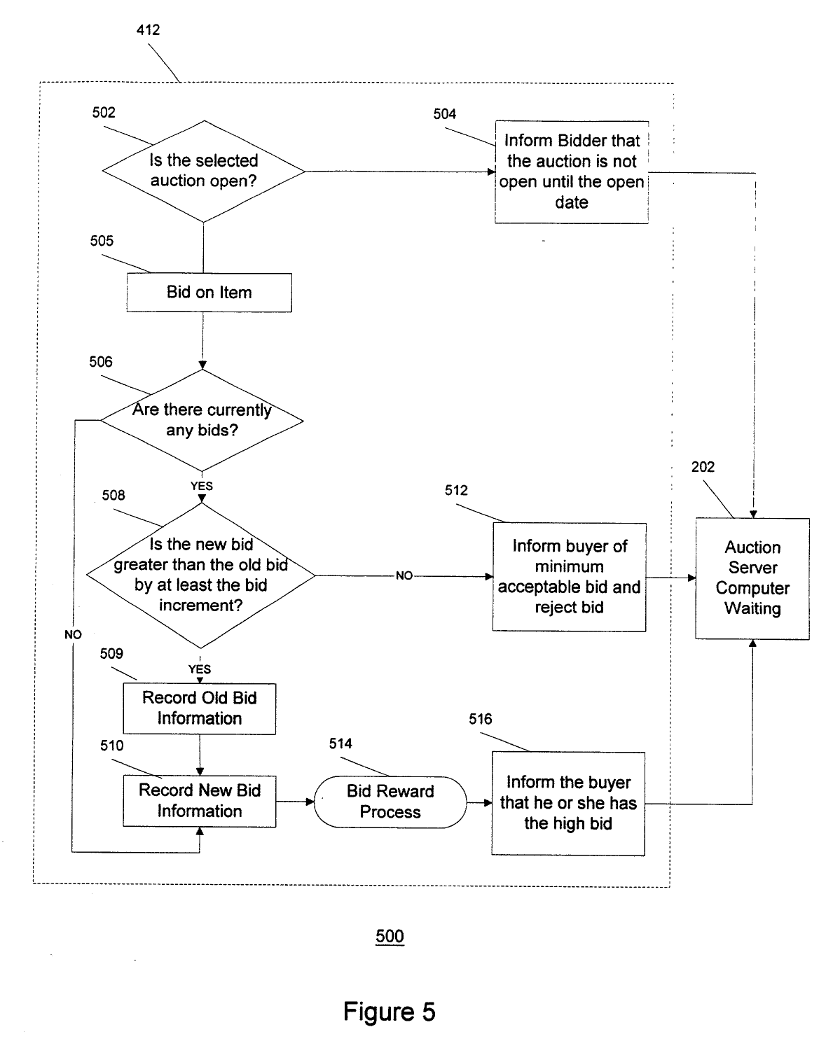

Referring now to FIG. 5, the auction central server 104 begins execution of the process block 412 by executing the decision block 502. The auction central server 104 reads the open date field 906 of the item profile 900 for the item the user selected. If the date specified by the open date field 906 is later than the current date, the auction central server 104 executes process block 504. The auction central server informs the user that the auction has not yet opened, rejects the user's bid, and returns to the wait state 202. If the date specified by the open date field 906 is earlier than or the same as the current date, the auction central server 104 executes process block 505.

Executing process block 505 causes the auction central server 104 to present the user with a screen that allows the user to bid on the selected item. The screen displays the amount stored in the current high bid field 916 from item profile 900 and has a data field for the user to input his or her bid. The user keys in a bid and submits that bid to the auction central server 104. The bid is stored in a temporary location new bid, and the auction central server 104 executes decision block 506.

Executing the decision block 506 causes the auction central server 104 to read the current high bid field 916 of the item profile 900 for the item the user is bidding on. If the current high bid field 916 is equal to a value outside the accepted range, the auction central server executes process block 510. If the current high bid field 916 is equal to a value within the accepted range, the auction central server executes decision block 508.

While executing decision block 508 the auction central server 104 reads the bid increment field 912 and the current high bid field 916 from the item profile 900 for the item currently being bid on. The auction central server 104 performs a calculation to ascertain whether the new bid is greater than the current high bid field 916 by at least the amount stored in the bid increment field 912. If it is, the auction central server 104 executes process block 509. Otherwise, the auction central server 104 executes process block 512. The auction central server 104 informs the user as to the minimum acceptable bid, rejects the user's current bid, and returns to the wait state 202.

Executing the process block 509 causes the auction central server 104 to write the current high bid field 916 and the current high bidder field 918 of the item profile 900 in the last high bid field 920 and the last high bidder field 922 respectively for the purposes of awarding a reward. The auction central server 104 then executes the process block 510.

Executing the process block 510 causes the auction central server 104 to write the user's username into the current high bidder field 918 of the item profile 900, and the user's bid into the current high bid field 916 of the item profile 900. The auction central server 104 then executes the process block 514.

Executing process block 514 causes the auction central server to award the reward if a reward is due. The auction central server 104 awards a reward to the user indicated in last high bidder field 922 if there is a last high bidder and if the last high bid field 920 is greater than the reserve price field 910. The auction central server 104 ascertains whether there is a last high bidder by reading the last high bidder field 922. If the last high bidder field 922 equals a value outside the accepted range, then there is no last high bidder and therefore no reward is awarded. Preferably, the reward is a credit which gets credited to the auction credit field 808 of the user's account profile 800 for the user specified in the last high bidder field 922. The credit gets credited after the date specified by the close date field 908 for the item. In an alternate embodiment, the reward can be anything of value to the user. The reward can be cash, goods or services. Preferably, the reward is valued at one half of the bid increment field 912, but it can be set to any amount. In an alternate embodiment, the reward is awarded to all last high bidders. In another alternate embodiment, the reward is awarded to all users whose username is stored in the current high bidder field 918. In another alternate embodiment, the reward is awarded to all users who bid on an item. In yet another alternate embodiment, the reward is awarded only to the final user whose name is stored in the last high bidder field 922. After the reward is awarded, the auction central server 104 executes process block 516.

Executing process block 516 causes the auction central server 104 to inform the user that the user is the current high bidder. After the auction central server 104 informs the user the auction central server 104 returns to the wait state 202. In another embodiment, the user identified in the last high bidder field 922 is informed that he or she is no longer the high bidder for the item.

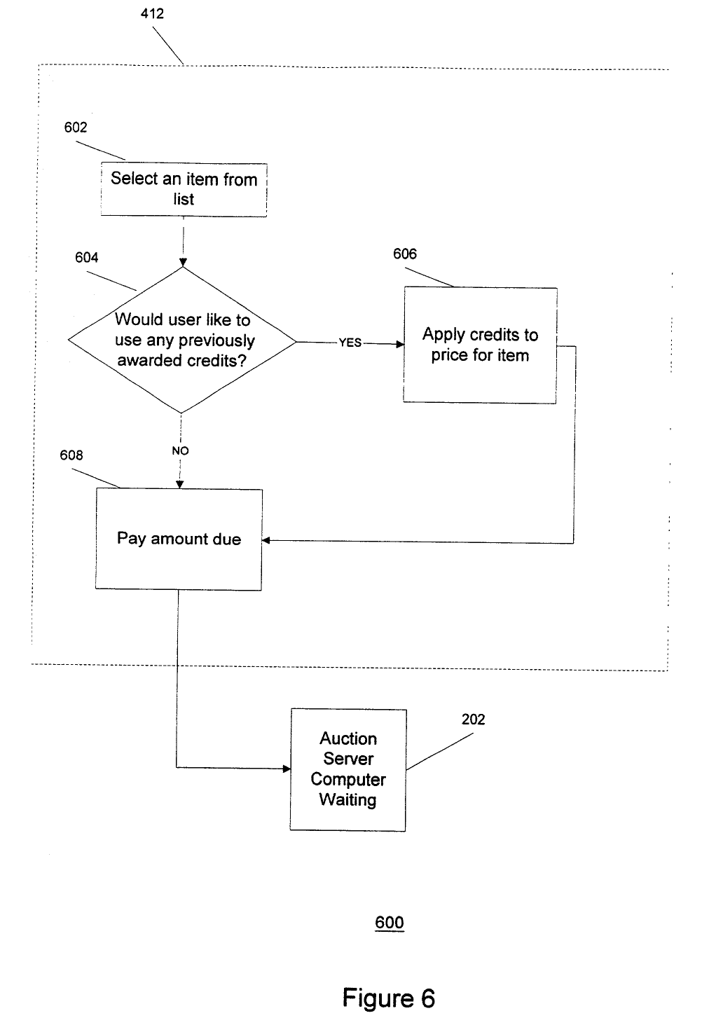

Process block 310 is shown in more detail in FIG. 6. The auction central server 104 begins executing process block 310 by executing process block 602. The auction central server 104 presents the user with a list of all the items stored in the database 104c where the user's username is recorded in the current high bidder field 918 in the item profile 900. The user picks one of the items listed and the auction central server 104 executes decision block 604.

Executing decision block 604 causes the auction central server 104 to present the user with the option of using previously awarded credits toward the purchase price for the item or simply buying the item. If the user indicates that the user wants to use previously awarded credits toward the purchase of the item, the auction central server 104 executes process block 606. If the user wants to simply buy the item, the auction central server 104 executes process block 608.

In an alternate embodiment, the user may use credits that were awarded for bidding on the item toward the purchase of that item.

Executing process block 606 causes the auction central server 104 to offer the user the opportunity to use the user's auction credit towards the purchase of the currently selected item. The auction central server 104 reads the auction credit field 808 of the user profile 800. The auction credit field 808 of the user profile 800 indicates how much credit the user has to use. Any of the credit stored in the auction credit field 808 of the user profile 800 can be used to purchase the selected item as long as it was not accrued by bidding on the selected item. The auction central server 104 presents a screen to the user that displays a message to the user showing the user's available auction credit and an input field where the user can indicate how much of the credit the user would like to user towards this purchase. The user inputs the amount into the input field. The auction system pays the selling user indicated in the seller's username field 914 of the item profile 900 the amount of the credit used in this purchase. The purchase price owed by the user is decreased by the amount of the credit applied to the purchase, the amount of the credit indicated by the auction credit field 808 is updated, and the process block 610 is executed.

Executing process block 608 causes the auction central server 104 to present a screen to the user asking how the user is going to pay for the selected item. The user can pay by any number of known methods including check, credit card, online payment system, and the like. After the user indicates the method of payment the auction central server 104 returns to the wait state 202.

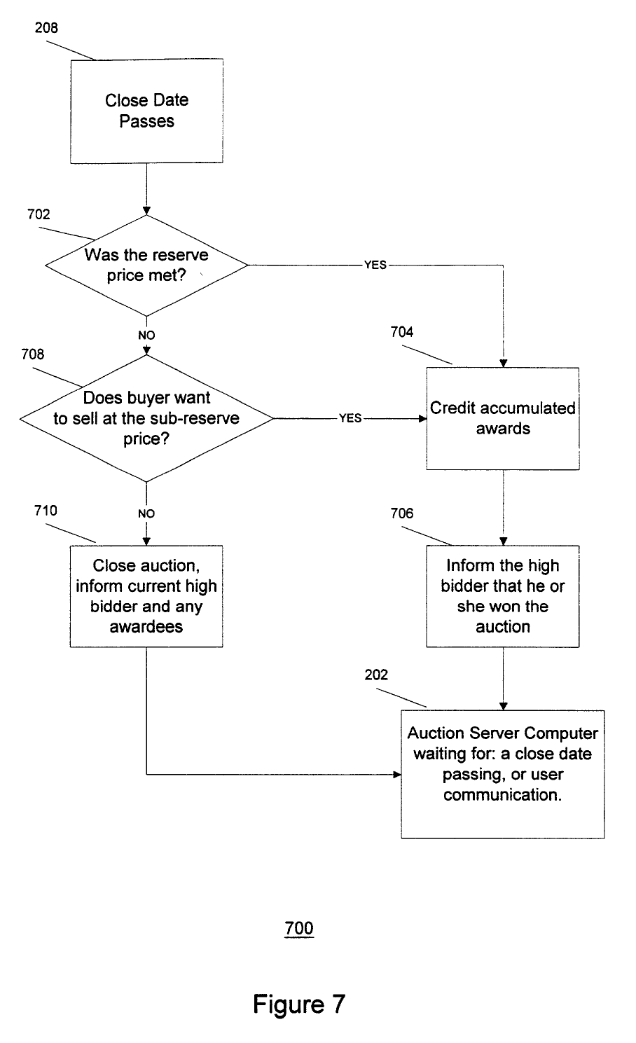

Referring now to FIG. 7, the auction central server 104 continues running auctions and reacting to communications from users until an auction closes. An auction closes on the date that is specified by the close date field 908 of the item profile 900. No bids are accepted after the date specified by the close date field 908 has passed. Once a close date has passed the auction central server 104 executes process block 208. Upon execution of process block 208 the auction central server 104 executes decision block 702.

Executing the decision block 702 causes the auction central server 104 to compare the current high bid field 916 of the item profile 900 with the reserve price field 910 of the item profile 900. If the current high bid field 916 is greater than or equal to the reserve price field 910 the auction central server 104 executes process block 704. If the current high bid field 916 is less than the reserve price field 910 the auction central server 104 executes decision block 708.

Executing the decision block 708 causes the auction central server 104 to communicate with the user specified in the seller's username field 914 of the item profile 900, such as by electronic mail (email). The email asks the user whether the user would like to sell the item for the price specified by current high bid field 916. If the user does not want to sell the item for the value specified in the current high bid field 916, the auction central server 104 executes process block 710. The auction central server 104 informs the user specified by the current high bidder field 918 and any awardees that the item did not sell, the auction is complete, and the auction central server 104 returns to the wait state 202. If the item does not sell no rewards are awarded. If the user would like to sell the item for the value stored in the current high bid field 916, the auction central server 104 executes process block 704.

In one embodiment, if the user would like to sell the item for the value stored in the current high bid field 916, the user can lower the value stored in the reserve price field 910 such that the value stored in the reserve price field 910 is lower than the amount stored in the current high bid field 916. The auction central server 104 can then execute process block 704.

Executing process block 704 causes the auction central server 104 to distribute the awards that have been accrued during the auction of the item. The auction central server 104 updates each user's account with the reward information. In one embodiment, the reward can only be used within the system to bid on items in the future, but a distributed Internet-based reward system like FREERIDE could also be used. In another embodiment, the reward may be claimed as a cash prize, a prize of goods, or a prize of services. In yet another embodiment, the reward may be used within the system to bid on the current item.

In one embodiment, the awards are distributed only if the value stored in the current high bid field 916 is greater than or equal to the value stored in the reserve price field 910.

Once the awards have been awarded to the proper users, the auction central server 104 executes process block 706. The auction central server 104 emails the user specified in the current high bidder field 918 that he or she was the high bidder at the close of the auction, and returns to the wait state 202.

The present systems and methods have been described in the context of certain preferred embodiments thereof. For the sake of clarity, the operation has generally been described in connection with the auction of a single item. However, it will be appreciated that generally, thousands of auctions of the type described will take place concurrently in a typical system. Further, other changes and modifications can be effected by those skilled in the art. It is intended that such changes are considered within the scope of the present invention as set forth in the appended claims.

What is claimed:

1. A method for auctioning items, comprising:
having a first user of a plurality of users put an item up for auction on a central database;
having a second user of a plurality of users enter a first bid at a first price for the item on the central database;
having a third user of said plurality of users bid a second bid at a second price exceeding the first price for the item on the central database; and,
awarding the second user a reward for bidding on the item.

2. The method for auctioning items of claim 1, wherein the first user describes the item in an item profile.

3. The method for auctioning items of claim 2, wherein the item profile comprises a name for said item.

4. The method for auctioning items of claim 2, wherein the item profile comprises a description for said item.

5. The method for auctioning items of claim 2, wherein said item profile comprises an open date for the auction of said item.

6. The method for auctioning items of claim 5, wherein the open date for said item describes the time after which the first bid will be accepted for the item.

7. The method for auctioning items of claim 2, wherein said item profile comprising a close date for the auction of said item.

8. The method for auctioning items of claim 7, wherein the close date for said item describes the time after which the second bid will not be accepted for the item.

9. The method for auctioning items of claim 7, wherein said reward is not credited to the first one of the plurality of buyers until after the close date for the item.

10. The method for auctioning items of claim 2, wherein said item profile comprises a reserve price for said item.

11. The method for auctioning items of claim 10, wherein the reserve price for said item describes an amount at which the first user must sell the item.

12. The method for auctioning items of claim 2, wherein said item profile comprises a bid increment for said item.

13. The method for auctioning items of claim 12, wherein the bid increment for said item describes the minimum amount by which said second bid must exceed said first bid.

14. The method for auctioning items of claim 12, wherein said reward is valued at a percentage of the bid increment.

15. The method for auctioning items of claim 14, wherein said percentage is fifty.

16. The method for auctioning items of claim 1, wherein said plurality of users communicates with the central database through a communication link over a communications network.

17. The method for auctioning items of claim 16, wherein said communications network is the Internet.

18. The method for auctioning items of claim 1, wherein said first user creates a first user profile before putting the item up for auction.

19. The method for auctioning items of claim 1, wherein said second user creates a second user profile before bidding on the item.

20. The method for auctioning items of claim 19, wherein the amount of said first bid and the identity of said second user is recorded in the central database.

21. The method for auctioning items of claim 1, wherein said third user creates a third user profile before bidding on the item.

22. The method for auctioning items of claim 21, wherein the amount of said second bid and the identity of said third user is recorded in the central database.

23. A system for auctioning items, comprising:
a communications network;
at least one seller connected to a central database through the communications network;
a plurality of buyers connected to the central database through the communications network;
one of the at least one seller putting an item up for auction on the central database;
a first one of the plurality of buyers bidding a first bid of a first price for the item on the central database;
a second one of the plurality of buyers bidding a second bid of a second price exceeding the first price for the item on the central database; and,
the central database awarding the first one of the plurality of buyers a reward for bidding on the item.

24. A central server computer for providing auction services to a plurality of buyers and sellers, the central server computer comprising:
a communications interface for operatively coupling the central server computer to a communications network;
digital storage media maintaining an auction database;
a processor coupled to the communications interface and the digital storage media, the processor creating a database record in the digital storage media in response to data received via the communications interface from a seller posting an item for auction, the processor making the database record available to a plurality of buyers via the communications interface, the processor recording a first bid from a first buyer at a first price for the item in the digital storage media and recording a second bid from a second buyer at a second price exceeding the first price for the item in the digital storage media; and
recording an award to the first buyer in the digital storage media for bidding on the item.

25. The central server computer of claim 24, wherein the database record comprises a name for said item for auction.

26. The central server computer of claim 24, wherein the database record comprises a description for said item for auction.

27. The central server computer of claim 24, wherein the database record comprises an open date for the auction of said item for auction.

28. The central server computer of claim 27, wherein the open date for said item describes the time after which the first bid will be accepted for said item for auction.

29. The central server computer of claim 24, wherein the database record comprises a close date for the auction of said item for auction.

30. The central server computer of claim 29, wherein the close date for said item for auction describes the time after which the second bid will not be accepted.

31. The central server computer of claim 29, wherein said reward is not credited to the first buyer until after the close date for the item for auction.

32. The central server computer of claim 24, wherein the database record comprises a reserve price for said item for auction.

33. The central server computer of claim 32, wherein the reserve price for said item for auction describes an amount at which the seller must sell the item for auction.

34. The central server computer of claim 24, wherein said database record comprises a bid increment for said item.

35. The central server computer of claim 34, wherein the bid increment for said item describes the minimum amount by which said second bid must exceed said first bid.

36. The central server computer of claim 34, wherein said reward is valued at a percentage of the bid increment.

37. The central server computer of claim 36, wherein said percentage is fifty.
